(19) United States
(12) Patent Application Publication
(10) Pub. No.: US 2002/0156669 A1
(43) Pub. Date: Oct. 24, 2002

(54) Method of determining a schedule, scheduler and system

(76) Inventors: Wilhelmus Franciscus Johannes Verhaegh, Eindhoven (NL); William Edward Peter Van Der Sterren, Eindhoven (NL)

Correspondence Address: US Philips Corporation, Intellectual Property Department, 580 White Plains Road, Tarrytown, NY, 10591, US

(21) Appl. No.: 10/069,742

(22) PCT Filed: Jun. 20, 2001
(86) PCT No.: PCT/EP01/07068

(30) Foreign Application Priority Data
Jun. 27, 2000 (EP) 00202245.7

(51) Int. Cl. G06F 17/60

(52) U.S. Cl. 705/8

(57) ABSTRACT

A scheduler (100) which implements a method for determining a flexible schedule (205) for executing a plurality of tasks (301-308) in a system having a plurality of resources (101-103, 109-113). The schedule (205) comprises for each task (301-308) a starting time, an ending time, an assignment of resources (101-103, 109-113) to said task (301-308), as well as a collection of times and processing speeds. Using this information, the execution of a task can vary in speed when for example multiple tasks need the same resource. To do this, the scheduler first defines a partial schedule using windows (w₀ , . . . , w₁₅) and then determines the length of the windows (w₀ , . . . , w₁₅) and the processing speed of each task in each window using linear programming and column generation.

The invention relates to a method of determining a schedule for executing a plurality of tasks requiring a plurality of resources.

The invention further relates to a scheduler for determining a schedule for executing a plurality of tasks requiring a plurality of resources.

The invention further relates to a system having such a scheduler.

When multiple tasks are to be executed using multiple resources, there often are requirements on the execution of the tasks, and limitations on the capacity of the resources. For instance, in digital transmission systems, the transmission of a video stream requires a video server from which the stream originates, a conditional access module which encrypts the stream to prevent unauthorized viewing, a gateway to a transmission medium and a transmitter such as a satellite to transport the stream to the recipient. All of these resources have only limited bandwidth capacity, and there are many possible requirements on the video stream. The stream could be required to start at nine o'clock, or the transmitted bit rate could have a required rate of at least 28 kilobits per second. In other fields, such as factories which produce multiple products on multiple machines, or schools which need to assign teachers and equipment to classrooms, such that classes of students can receive education, there are likewise resources with limited capacity and tasks with certain requirements. A teacher in a school environment, for example, may have the limitation that he can only teach 25 students at a time. To ensure a satisfactory execution of the tasks, adding more resources is not always an acceptable option, as it may be very costly to add additional machines in a factory or transmission lines with higher capacity.

Thus, there exists a scheduling problem, in which the system responsible for executing the tasks has to determine when and how to execute the tasks, within the limitations on the available resources and the requirements for execution derived from the tasks themselves. It is essential to optimally use the available resources in order to give an as good as possible performance in executing the tasks. The scheduling of the execution of these tasks therefore is very important.

A disadvantage of current scheduling techniques is that the processing speed for each task to be executed is usually determined in advance, and remains constant during the execution of said task. Thus, if two or more tasks simultaneously occupy the same resource, the processing capacity of that resource must be at least the sum of the processing speeds of the tasks in question. However, some types of tasks allow a variation in processing speed during their execution. For instance, the transmission of digital video content can be done with a variable bit rate, as long as some minimal bit rate is achieved. Current scheduling techniques are not flexible enough to make use of this property. The operator of a system using a schedule produced by such a scheduling technique must manually intervene and vary the processing speed of some task if the load becomes too high, and then recompute the schedule for the new situation.

It is an object of the present invention to provide a method according to the preamble, which can determine a flexible and efficient schedule for executing a plurality of tasks requiring a plurality of resources.

To meet this object of the invention, the method comprises the step of

(a) constructing a set of constraints from given requirements of each task and from given limitations on each resource;

(b) determining for each task a relative starting time, a relative ending time and an assignment of resources, based on the constraints from said set;

(c) determining for each task an absolute starting time, an absolute ending time and a collection of times and associated task processing speeds, based on the determined relative starting time, relative ending time and assignment of resources for said task, minimizing any violation of the constraints from said set; and

(d) determining the schedule, comprising for each task the determined absolute starting time, absolute ending time, collection of times and associated task processing speeds and assignment of resources to said task.

The schedule produced by this method not only provides for each task an absolute starting time and absolute ending time, but also an assignment of resources and a collection of times and associated task processing speeds. This collection provides the desired flexibility in the processing of each task. The times in the collection can be interpreted as time points, at which time the processing speed of the task in question should be changed to the task processing speed associated with that time point. The task processing speed can then optionally vary by small amounts until the next time point. Alternatively, two subsequent times in the collection can be interpreted to encompass a time interval, during which the task processing speed has to remain constant, at the level of the given task processing speed associated with the lowest of the two times.

The assignment of resources for a task identifies the specific resources to be used in the execution of that task. A teaching task may have the requirement that it needs, for instance, a teacher, a classroom and an overhead projector, and the assignment of resources then specifies that teacher Johnson can use overhead projector THX 1138 in classroom 3B.

In an embodiment of the method, step (c) comprises

defining a sequence of windows, a starting time of a window from said sequence corresponding to one of the relative starting time and the relative ending time of a task, and an ending time of said window corresponding to a starting time of a next window in said sequence;

determining an absolute length of the windows from said sequence, minimizing any violation of the constraints from said set;

determining for each window a processing speed for each task and creating for each task a collection of times and associated task processing speeds based thereupon, minimizing any violation of the constraints from said set; and

determining for each task the absolute starting time and the absolute ending time from the absolute length of the windows.

After introducing the windows, which are time periods between starting times and ending times of tasks, the method of this embodiment can compute the absolute length of the windows, minimizing any violation of the constraints. When the requirements on the starting times and ending times are very strict, there may be only a small number of feasible solutions. For each window a processing speed is computed for each task, and given the length of the windows, the above-mentioned collection of times and associated task processing speeds can easily be derived. The starting time of a window can be used as the time point with which the task processing speeds for that window are to be associated, or the length of the windows can be used to derive the time interval during which the task processing speed should be constant, at the level of the computed task processing speed. The absolute starting and ending times for the tasks are determined from the window lengths. Because the starting times of the windows correspond to starting and ending times of the tasks, and the absolute length of the windows has been computed previously, all that is needed is one fixed time point. Given this time point, which can be input by the operator, or be defined as the current time or some specific time in the future when the schedule is computed, all absolute window widths are easily converted to absolute starting and ending times for the tasks.

In a further embodiment the method comprises the step of

determining whether any violation of the constraints has occurred, and if so,

determining at least one of a new relative starting time for a task, a new relative ending time for a task, and a new assignment of a resource to a task; and

executing step (c).

The schedule as obtained by the method according to the invention should ideally fully satisfy the constraints. A particular solution may have a number of violations, which may be impossible to avoid given a particular ordering of starting and ending times or a given assignment of resources. In that case, it is advantageous to re-order tasks or to change the assignment of resources. Then, given the new ordering or assignment, or both, a new schedule can be determined. If this schedule also violates some of the constraints, yet another re-ordering or renewed assignment can be performed. If executing the method for a certain amount of time does not result in a schedule fully satisfying the constraints, it may be that there is no feasible solution to the scheduling problem. In that case, the schedule with the minimal violation should be chosen. Additionally, the constraints could be eased, for example by adding more resources or more capacity to existing resources.

In a further embodiment of the method, the step of determining the absolute length of the windows from said sequence comprises solving a linear programming problem. An advantage of this embodiment is that linear programming is a simple and fast method of obtaining a solution to a problem of the kind described above.

In a further embodiment of the method, the step of determining for each window a processing speed for each task comprises solving a linear programming problem. An advantage of this embodiment is that this step can be combined with the step of determining the absolute length of the windows into a bilinear programming problem, for which a solution can then be derived by means of linear programming with column generation.

It is a further object of the present invention to provide a scheduler according to the preamble, which can determine a flexible and efficient schedule for executing a plurality of tasks requiring a plurality of resources.

To meet this object of the invention, the scheduler comprises

constructing means for constructing a set of constraints from given requirements of each task and from given limitations on each resource;

ordering means for determining for each task a relative starting time, a relative ending time and an assignment of resources, based on the constraints from said set;

timing means for determining for each task an absolute starting time, an absolute ending time and a collection of times and associated task processing speeds, based on the determined relative starting time, relative ending time and assignment of resources for said task, minimizing any violation of the constraints from said set; and

scheduling means for determining the schedule, comprising for each task the determined absolute starting time, absolute ending time, collection of times and associated task processing speeds and assignment of resources to said task.

In an embodiment of the scheduler the timing means are arranged to

define a sequence of windows, a starting time of a window from said sequence corresponding to one of the relative starting time and the relative ending time of a task, and an ending time of said window corresponding to a starting time of a next window in said sequence;

determine an absolute length of the windows from said sequence, minimizing any violation of the constraints from said set;

determine for each window a processing speed for each task and create for each task a collection of times and associated task processing speeds based thereupon, minimizing any violation of the constraints from said set; and

determine for each task the absolute starting time and the absolute ending time from the absolute length of the windows.

In a further embodiment the scheduler is arranged to

determine whether any violation of the constraints has occurred, and if so, to

determine at least one of a new relative starting time for a task, a new relative ending time for a task, and a new assignment of a resource to a task; and

activate the timing means.

In a further embodiment the scheduler comprises linear programming means for solving a linear programming problem.

It is a further object of the present invention to provide a system having such a scheduler.

These and other aspects of the invention will be apparent from and elucidated with reference to the embodiments shown in the drawing, in which:

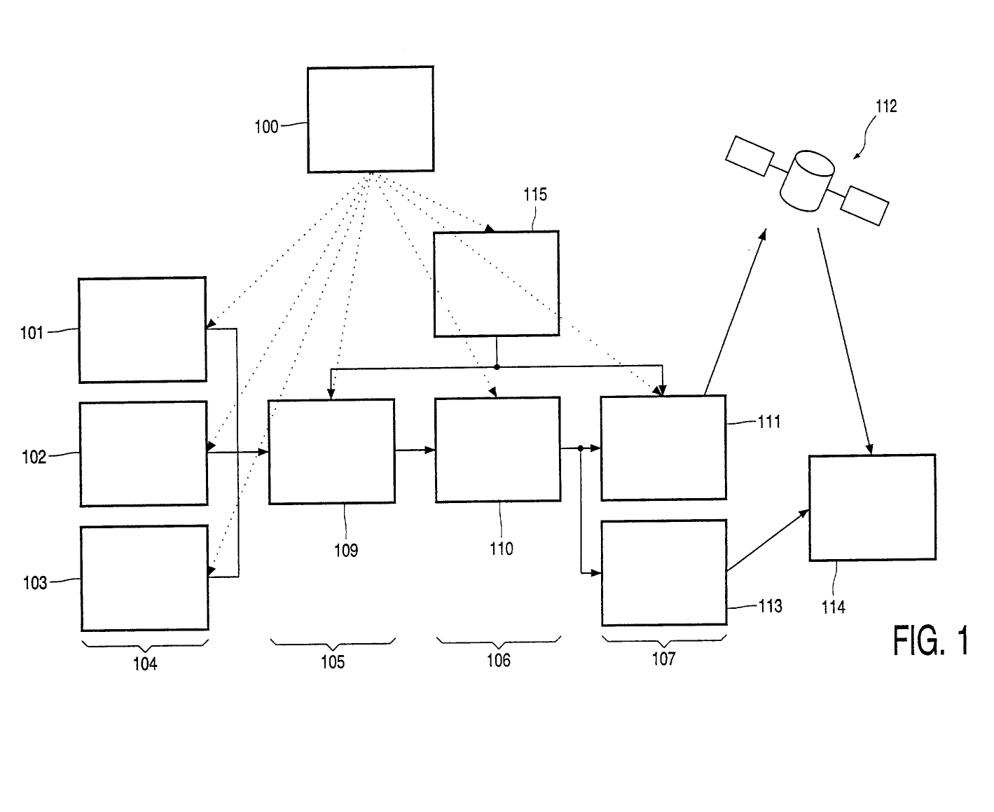

FIG. 1 is a block diagram of a transmission system having a scheduler according to the invention;

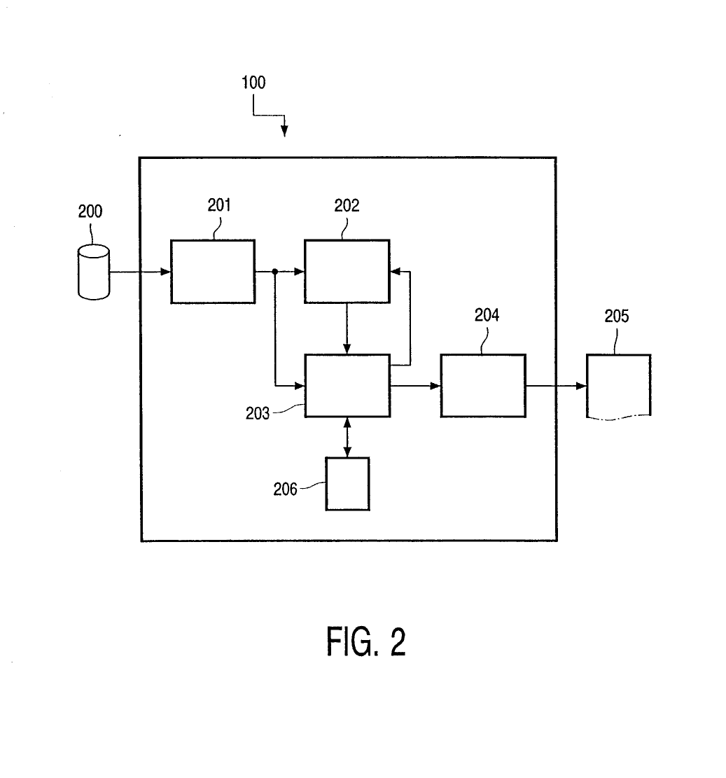

FIG. 2 is a block diagram of a scheduler according to the invention; and

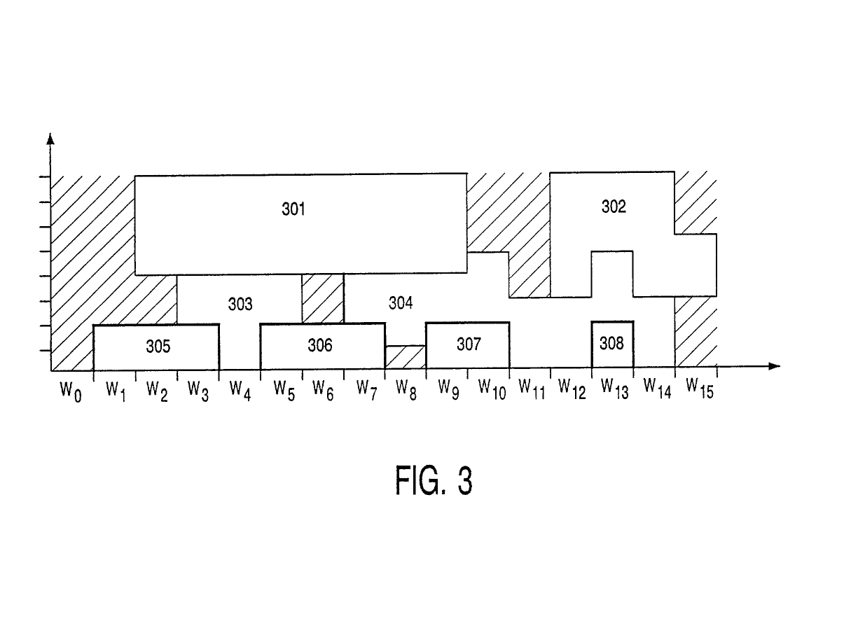

FIG. 3 shows an example schedule.

Throughout the figures, same reference numerals indicate similar or corresponding features. Some of the features indicated in the drawings are typically implemented in software, and as such represent software entities, such as software modules or objects.

FIG. 1 shows a block diagram of a system having a scheduler 100 and a plurality of resources 101, 102, 103, 109, 110, 111, 112, 113, 114, 115. The system of FIG. 1 is a digital video transmission system, which can transmit content from a plurality of sources, such as a video server 101, a carousel server 102 or an IP tunnel 103, to a receiver 114. Before transmission, the content may be encrypted to prevent unauthorized access. To this end, the content is fed through an IP encryptor 109. After that, the content is fed through an IP-DVB gateway 110, which multiplexes the various content portions into one digital video stream, suitable for transmission. The multiplexed stream is then transmitted to the receiver 114 through various means, such as a conventional land line or a satellite connection. Transmitter 113 provides access to a land line, and uplink 111 can transmit the stream to a satellite 112. The receiver 114 receives the stream from these various means, and demultiplexes, decodes and processes the content as desired. A conditional access module 115 can also be present, to manage, for instance, access rights to portions of the content for various receivers 114. The scheduler 100 determines a schedule for executing all these tasks on all these resources in the most efficient way. The system is arranged to execute the tasks in accordance with the schedule obtained from the scheduler 100.

Although the scheduler 100 is shown here as part of a digital video transmission system, it can also be applied in a great variety of other systems. In a school, for instance, the scheduler 100 can be used to efficiently plan the use of the various classrooms, teachers and available equipment such as blackboards, overhead projectors and television systems. In a factory, the schedule obtained from the scheduler 100 can be used to execute various production runs on the available machines, using the equipment, resources and workers in an efficient way.

It is assumed that all resources needed for the execution of a task are all occupied simultaneously during the execution. For instance, in a factory, producing a good may require a worker along with several pieces of equipment and a certain amount of supplies such as paint. In a school environment, each teacher needs a classroom, equipment such as a blackboard, an overhead projector or a number of computers. All these resources are used simultaneously when a class of students is being taught.

Each task has an associated list of required resource types. Assigning resources for a task therefore involves selecting the resources which have the required types. In a school environment, a teaching task may need a classroom, a teacher and a blackboard. The actual assignment could then result in classroom 10, teacher Bowman and blackboard H9000 being selected for this teaching task. Another teaching task may also need a classroom and a teacher, but instead of a blackboard it needs an overhead projector. The assignment could result in classroom 11, teacher Lucas and overhead projector THX 1138 being selected for this teaching task. This requires that for each resource, its type is known, so that the appropriate resources are assigned and the requirement is satisfied.

It may be advantageous to divide the plurality of resources into several distinct sets, each set having resources with similar characteristics. For instance, in a school environment, there could be a set of classrooms, a set of teachers and a set of overhead projectors. The assignment of resources for each task can then be simplified to taking one element from each set. This saves having to inspect the type of each resource during assignment. In FIG. 1, the sources 101, 102, 103 form a first group 104. There is only one IP encryptor 109, so the second group 105 only has one member. Similarly, the third group 106 only has the IP-DVB gateway 110 as a member. The fourth group 107 is formed by the transmission means 111, 113. Each portion of the content must be executed on one of the various resources of each group 104, 105, 106, 107.

The scheduler 100 is shown in more detail in FIG. 2. It comprises a constructing module 201, an ordering module 202, a timing module 203 and a scheduling module 204. The scheduler 100 may further comprise a linear programming module 206, which are used to solve the scheduling problem.

The constructing module 201 receive a series of requirements of each task and limitations on each resource from a source 200, and construct a set of constraints based thereupon.

The requirements of a task a from a set A of tasks at least comprise a release time, denoted by r(a), and a deadline or due time, denoted by d(a). These times indicate the earliest time at which the execution of the task a may begin, and the time at which the execution of the task a must have been completed, respectively. There can further be requirements on the processing speed of the task a. The minimal processing speed of the task a is given by pₘᵢₙ(a), and the maximal processing speed is given by pₘₐₓ(a). The task a may have a lower bound on a portion of the task that is processed, for instance, in digital video transmission, there may be a lower bound on the transmitted content size. This is denoted by c(a). The task a may further have a value, denoted by v(a). The value of the tasks can be used to make a trade-off between different executions to be scheduled. The first scheduling objective, as defined below, is to maximize a weighted sum of the scheduled executions, and the above mentioned values are their weight factors. Note that the values can also be used to indicate different priority classes, by choosing the values of high priority classes much larger than for low priority classes.

The time during which execution of the tasks takes place can be divided into a sequence of windows. A task a may have a lower bound tₘᵢₙ(a) and an upper bound tₘₐₓ(a) on the length of the time of its execution. The concept of windows is explained further below.

Tasks may be related in some way. One task may be required to start before or after another. Two tasks might have to start at the same time or with a specific time in between. A task may have to wait until another task has been completed, and so on. To this end, four timing relationships are defined, Tₛₛ, T_{sc}, T_{cs} and T_{cc}, indicating the start-start, start-completion, completion-start and completion-completion relations. These will be explained below when the precedence constraints are explained.

The limitations of a resource r at least comprise an upper limit on its processing capacity, denoted by p(r) and a bound on the number of tasks it can execute simultaneously, denoted by n(r). When resources are grouped, the resources in each group are denoted by Rⱼ for group j. The assigned resources to a task are denoted by ρⱼ(a), which is an element from Rⱼ.

For each task a and each group j there can further be a lead-in time lⱼⁱⁿ(a) and a lead-out time lⱼ^{out}(a), denoting that right before and after the execution of the task on the resource chosen from that group, that resource is also used by that task. Each resource r further can have an associated availability window. The starting time of this availability window is denoted by s(r) and the ending time is denoted by e(r). The resource is only available for the duration of the availability window. To model the situation in which the resource is available and unavailable multiple times, the resource should be defined two times, each time with a different availability window.

A resource r further can have several types of overhead. The fixed overhead is denoted by o(r), and the variable overhead is denoted by q(r). Thus, in the case of video transmission, an input stream with bit rate x will result in an output stream with bit rate o+qx.

It may be required that several resources are to be used together, or a specific combination may be forbidden. This limitation is modeled by adding a set C, which only has an element (r, r′) if resource r from group j may be combined with resource r′ from group j′. Similarly, it may be required or forbidden that two tasks, which use the same resources from one group, must also use the same resource from another group. This is modeled by a set U, which only has an element (j,j′) if an assignment of the same resource from group j to several task implies an assignment of the same resource from group j′ to those tasks.

The schedule determines when executions take place and which resources are used in the course of each execution. Furthermore, it determines the task processing speeds used during the execution. To the latter end, execution profiles are defined as a collection (τ₀,π₁,τ₁,π₂, . . . , πₘ,τₘ) of time points τ and task processing speeds π, denoting that in the time interval (τₖ₋₁,τₖ) the task processing speed is πₖ. The absolute starting time of an task a is denoted by τₛₜ(a) and the absolute ending time by τ_{cp}(a).

Thus, the schedule comprises an absolute starting time τₛₜ(a) and the absolute ending time τ_{cp}(a), a collection of times and associated task processing speeds (τ₀,π₁,τ₁,π₂, . . . , πₘ,τₘ) and an assignment of resources ρⱼ(a) for each group j. It may happen that some tasks cannot be scheduled, for instance because the required resources are not available. It may still be advantageous to include those tasks in the schedule, so that the interrelationships between unscheduled and scheduled tasks are not lost. For example, if a first scheduled task should come after an unscheduled task, and that unscheduled task should come after a second scheduled task, then removing the unscheduled task completely will mean that the constraint of the first task coming after the second task is lost. The set of scheduled tasks is denoted by A*. The difference between tasks from the fill set A or the limited set A* is not relevant, unless explicitly noted otherwise.

There are several types of constraints that a schedule has to satisfy. The first type of constraints are the execution time constraints, specifying that for each task a the following should hold:

τₛₜ(a)≧r(a) [symbol] τ_{cp}(a)≦d(a) [symbol] tₘᵢₙ(a)≦τ_{cp}(a)−τₛₜ(a)≦tₘₐₓ(a)

In other words, the absolute starting time should be at least the release time, and the absolute ending time should be at most the due time. The duration of the execution, defined as the difference between absolute starting time and absolute ending time, should be between the given minimal and maximal execution times.

The second type of constraints are the precedence constraints. For two tasks a and b, the following constraints are constructed:

τₛₜ(a)+x≦τₛₜ(b) if (a,b,x)εTₛₛ

τₛₜ(a)+x≦τ_{cp}(b) if (a,b,x)εT_{sc}

τ_{cp}(a)+x≦τₛₜ(b) if (a,b,x)εT_{cs}

τ_{cp}(a)+x≦τ_{cp}(b) if (a,b,x)εT_{cc}

where Tₛₛ, T_{sc}, T_{cs} and T_{cc} denote the start-start, start-completion, completion-start, and completion-completion timing relations between executions of tasks. An element (a,b,x) is in the set Tₛₛ if there must be time x between the start of a and the start of b. An element (a,b,x) is in the set T_{sc} if there must be time x between the start of a and the completion of b, and similar for the other two sets T_{cs} and T_{cc}. In other words, these constraints enforce the timing relations between the tasks.

The third type of constraints are the execution constraints, specifying that for a resource r, the number of tasks a simultaneously occupying the resource r may not exceed its bound n(r). There is also a lead-in time lⱼⁱⁿ(a) and a lead-out time lⱼ^{out}(a) to be considered. An occupation function αⱼ(a, t), giving the time at which a task a occupies a resource from group j is defined by

$${α}_{j} ( a , t ) = \{ \begin{matrix}1 & if t ∈ [ {τ}_{st} ( a ) - {l}_{j}^{in} ( a ) , {τ}_{cp} ( a ) + {l}_{j}^{out} ( a ) ) \\ 0 & otherwise\end{matrix}$$

From this function, the execution constraints can be defined as follows:

$${\sum }_{{a}^{′} {ρ}_{j} ( a ) = r} {α}_{j} ( a , t ) \leq \{ \begin{matrix}n ( r ) & if t ∈ [ s ( r ) , e ( r ) ) \\ 0 & otherwise\end{matrix}$$

The fourth type of constraints are the execution profile constraints, specifying that for each execution of a task a the execution profile (τ₀,π₁,τ₁,π₂, . . . , πₘ,τₘ) must satisfy

$${p}_{min} ( a ) \leq {π}_{k} \leq {p}_{max} ( a ) for all k = 1 , … , m$$

$${\sum }_{k = 1}^{m} {π}_{k} ( {τ}_{k} - {τ}_{k - 1} ) \geq c ( a )$$

The fifth type of constraints are the resource processing constraints. A task processing speed function, which gives the processing speed of a task a ε A* at any point in time is given by

$$π ( a , t ) = \{ \begin{matrix}{π}_{k} & if t ∈ [ {τ}_{k - 1} , {τ}_{k} ) for a k = 1 , … , m \\ 0 & otherwise\end{matrix}$$

for a task a with execution profile (τ₀,π₁,τ₁,π₂, . . . , πₘ,τₘ). Overhead in resources can be modeled by defining an output task processing speed function for resource ρⱼ(a) from group j, as follows:

$${π}_{j} ( a , t ) = \{ \begin{matrix}o ( {ρ}_{j} ( a ) ) + q ( {ρ}_{j} ( a ) ) {π}_{j - 1} ( a , t ) & if t ∈ [ {τ}_{st} ( a ) , {τ}_{cp} ( a ) ) \\ 0 & otherwise\end{matrix}$$

where π₀(a,t)=π(a,t) for all tasks a and times t. Using the task processing speed function, the resource processing constraints specify that for each group j, all resources r from group j and all times t, the following should hold:

$${\sum }_{a ∈ {A}^{*} \cdot {ρ}_{j} ( a ) = r} π ( a , t ) \leq p ( r )$$

The sixth type of constraints are the resource combination constraints, which ensure that the proper combination of resources is used, if necessary:

(ρⱼ(a),ρ_{j′}(a))εC

The seventh type of constraints are the unicity constraints. These specify that for all pairs of groups (j,j′) ε U and all tasks a, a′ the following should hold:

ρⱼ(a)=ρⱼ(a′)→ρ_{j′}(a)=ρ_{j′}(a′)

The ideal objective is to find a schedule containing all the tasks while satisfying all the constraints as defined above. However, possibly no solution exists in which all tasks can be executed without violating any constraint. In that situation, the objective is to maximize a weighted sum of the scheduled tasks, i.e., to maximize

$$f ( σ ) = {\sum }_{a ∈ {A}^{*}} v ( a )$$

for a schedule σ If more than one schedule σ exists with a maximal value for f, then the assigned task processing speeds should be optimized. A third objective could be to minimize the execution time of the task.

FIG. 3 shows an example schedule which could be obtained from the scheduler 100. There are a plurality of tasks 301, 302, 303, 304, 305, 306, 307, 308. The vertical axis indicates the task processing speed, using an arbitrary scale. The horizontal axis indicates the time. In the embodiment as described with reference to FIG. 1, these tasks could be a first movie 301, a transmission of financial files 302, a broadcast of a live sports event 303, a second movie 304, and several news bulletins 305, 306, 307, 308.

Although no absolute starting times and ending times are known, except for tasks for which the given release time and due time is very strict, e.g., a news bulletin should start at nine o'clock and last ten minutes, a relative ordering of the starting times and ending times is possible. The ordering module 202 creates such a relative ordering, and derives relative starting times and ending times from this ordering.

The time during which these executions takes place is divided into a sequence of windows w₀, w₁ , . . . , w₁₅. A starting time of a window from said sequence w₀ , . . . , w15 corresponds to one of the relative starting time and the relative ending time of a task, and an ending time of said window corresponding to a starting time of a next window in said sequence. In FIG. 3, for instance the starting time of window w₀ corresponds to the relative starting time of first movie 301, and its ending time corresponds to the starting time of window w₁. The starting time of this window, in turn, corresponds with the starting time of broadcast 303, and ends when window w₂ begins. This window begins when news bulletin 305 ends. The first window, w₀, is a special case. The starting time of this window corresponds to the time at which execution of the scheduled tasks should be started. It may be that the task which starts earliest still starts later than this time. In that case, there can be some slack time before the earliest starting task starts. This is then modeled using window w₀. Windows can have zero duration. When the absolute ending time of one task and the absolute starting time of another task are determined to be the same, then the size of the window between the ending time of the one task and the starting time of the other task will be zero. Conceptually, however, it still exists and must be taken into account.

It can easily be seen from FIG. 3 that the processing speeds of some tasks vary with time. For instance, the broadcast of a live sports event 303 doubles in bit rate during window w₂, and goes back to its starting bit rate during window w₃. However, the news bulletins 305, 306, 307, 308 maintain a constant bit rate.

The ordering module 202 determines for each task a relative starting time, a relative ending time and an assignment of resources, based on the constraints constructed by the constructing module 201. The relative ordering should ideally satisfy the constraints, since it will be used as input for the timing module 203, which computes the value to be used in the schedule. Using a relative ordering which does not satisfy the constraints may mean that the schedule derived from the computations performed by the timing module 203 is useless.

A similar argument can be made for the assignment of resources to each task. The ordering module 202 can use any way to determine this assignment, even a random algorithm, but preferably the assignment is checked to ensure it satisfies the relevant constraints.

The timing module 203 has the task of determining for each task an absolute starting time, an absolute ending time and a collection of times and associated task processing speeds. As an input, the timing module 203 receives for each task the determined relative starting time, relative ending time and assignment of resources from the ordering module 202. While determining the above-mentioned information from which the schedule 205 is constructed, the timing module 203 should minimize any violation of the constraints as received from the constructing module 201, ideally producing output which satisfies all the constraints.

After the timing module 203 has determined said information, the scheduler 100 can optionally determine whether any violation of the constraints has occurred. If it turns out that this is the case, it then determines at least one of a new relative starting time for a task, a new relative ending time for a task, and a new assignment of a resource to a task, for instance by activating the ordering module 202 to have it produce a new relative ordering or assignment. The scheduler 100 could also simply swap two relative time points or two assignments, or apply any other technique to change the original output of the ordering module 202. A local search approach provides satisfactory results in this regard. The local search approach is described e.g. by E. J. Anderson, C. A. Glass and C. N. Potts, “Machine scheduling”, published in E. H. L. Aarts and J. K. Lenstra (editors), Local Search in Combinatorial Optimization, John Wiley & Sons, 1997, ISBN 0-471-94822-5, pp. 361-414. After applying one such technique to change the partial schedule, the scheduler 100 then activates the timing module 203, to obtain new information from which a schedule 205 can be constructed.

The timing module 203 can solve the scheduling problem using linear programming, for which linear programming module 206 is provided. Using linear programming, the absolute length of the windows w₀ , . . . , w₁₅ is determined. For each window a task processing speed for each task is computed, and this provides the input to create for each task a collection of times and associated task processing speeds. The solution should ideally satisfy, but in any case minimize any violation of the constraints as provided by the constructing module 201.

The ordering module 202 has provided the timing module 203 with a relative ordering on the execution of the tasks, as well as with an assignment of resources to the tasks. The timing module 203 create a sequence of windows w₀ , . . . , w₁₅, corresponding to the starting and ending times of tasks. To determine the absolute starting and ending times, the absolute length of the windows w₀ , . . . , w₁₅ should be determined. Once the absolute length of the windows w₀ , . . . , w₁₅ is known, the absolute starting time and absolute ending time for each task can be computed easily. A suitable time point zero should be defined first. This could be the current time, or a given time at which the schedule is to be executed. This time point zero corresponds with the start of the window w₀. The lengths of the windows w₀ , . . . , w₁₅ can then be used to determine their respective absolute starting times. The starting times of the windows w₀ , . . . , w₁₅ correspond with the starting times or ending times of the tasks, thus a simple assignment of window starting times to the appropriate task starting or ending times suffices.

The constraints as derived by the ordering module 202 must now be translated to take the windows into account. For the execution time and precedence constraints, linear constraints on the w variables are of the form

w₀+ . . . +wₖ≧r

w₀+ . . . +wₖ≦d

tₘᵢₙ≦wₖ+ . . . +wₗ≦tₘₐₓ

wₖ + . . . +wₗ≦x or wₖ+ . . . +wₗ≧y

Combining the above constraints gives a system Dw≧d, with a certain matrix D and vector d of constants.

For the task processing speed bounds and the processing capacity constraints, linear constraints on the p variables are

$${p}_{i , min} \leq {π}_{ij} \leq {p}_{i , max}$$

$${\sum }_{i ∈ I ( r )} {π}_{ij} \leq p ( r )$$

where I(r) is the set of indices of scheduled activations assigned to resource r, and the minimum and maximum task processing speeds outside an activation's box are chosen equal to zero. The above constraints have to hold for each window j=0 , . . . , 15. This results in a system Aⱼπⱼ≧eⱼ, with certain matrices Aⱼ and vectors eⱼ of constants, where πⱼ denotes column j of matrix π. Note that below j always ranges from zero to fifteen, since there are sixteen windows in FIG. 3. If there are another number of windows, the upper limit of j will of course have to be adjusted.

The constraints on the total content of activations can be expressed in the form wₖβᵢₖ+ . . . +wₗβᵢₗ≧cᵢ, which results in a system πw≧c . This gives cross products between π and w variables.

The remaining constraints do not depend on the absolute values of the times and task processing speeds, so they can be checked already when a relative time ordering and resource assignment are known, and thus they can be omitted from this sub-problem. To summarize, the sub-problem can be formulated by the following set of constraints.

Aⱼπ_{.j}≧eⱼfor all j=0 , . . . , 15

Dw≧d (1)

πw≧c

The problem of equation 1 can be solved by means of linear programming with column generation. Column generation is described e.g. in A. Schrijver, Linear and Integer Programming, John Wiley & Sons, 1986, ISBN 0-471-90854-1, pp. 147-148.

To solve the problem, the above set of constraints is rewritten to

Aⱼπ_{.j}≧eⱼ for all j=0 , . . . , 15

$${\sum }_{j = 0}^{15} {w}_{j} [ \frac{{D}_{\cdot j}}{{π}_{\cdot j}} ] \geq [ \frac{d}{c} ] \qquad ( 2 )$$

and for each window j a set of feasible task processing speed assignments, given by

Pⱼ={p εQ⁸|p≧0 [symbol] Aⱼp≧eⱼ}

is introduced. Note that the number 8 is used because there are eight scheduled tasks 301, 302, 303, 304, 305, 306 307, 308. Instead of considering only one task processing speed assignment π_{.j} εPⱼ per window, all possible task processing speed assignments are considered. For each window, there now is a variable wⱼₚ for each window j=0 , . . . , 15 and each task processing speed assignment p ε Pⱼ, which have to satisfy

$${\sum }_{j = 0}^{15} {\sum }_{p ∈ {P}_{j}} {w}_{jp} [ \frac{{D}_{\cdot j}}{{}_{p}} ] \geq [ \frac{d}{c} ] \qquad ( 3 )$$

A solution of this problem can be used to easily determine a solution of equation 2 by taking

$${w}_{j} = {\sum }_{p ∈ {P}_{j}}^{} {w}_{jp} ⋀ {π}_{\cdot j} = {\sum }_{p ∈ {P}_{j}}^{} \frac{{w}_{jp}}{{w}_{j}} p$$

i.e., the sub-window widths are added up and the used task processing speeds are averaged out. By substitution it becomes clear that this solution satisfies the second inequality of equation 2. Furthermore, the first inequality of this equation is also satisfied, since the constructed π_{.j} is a convex combination of elements of the convex set Pⱼ, so π_{.j} itself is an element of Pⱼ too. Therefore, Aⱼπ_{.j}≧eⱼ holds.

To solve equation 3, there are an infinite number of variables wⱼₚ to be determined, since each set Pⱼ contains infinitely many elements. Although a restriction without loss of generality can be made to the extreme points of the polytope Pⱼ, this still would require too many variables and too many columns to be generated for the corresponding linear programming tableau. This can be overcome by using a column generation technique, meaning that only a subset \tilde{P}ⱼ⊂Pⱼ for each window j is considered. The subset is initially taken empty and new elements are added iteratively.

So, this gives a derived problem in which to

$$minimize {\sum }_{k} {x}_{k} + {\sum }_{i} {y}_{i}$$

$$subject to {\sum }_{j = 0}^{15} {\sum }_{p ∈ {\tilde{P}}_{j}}^{} {w}_{jp} [ \frac{{D}_{\cdot j}}{p} ] + [ \frac{x}{y} ] \geq [ \frac{d}{c} ]$$

where penalty variables x and y have been added to have a feasible system at all times. Initially, \tilde{P}ⱼ=Ø for all windows j, and the above system is then optimized. Next, each window wⱼ is considered iteratively to check whether an element of Pⱼ exists that may decrease the total penalty when adding it to \tilde{P}ⱼ, i.e., that has a negative reduced cost in the optimized tableau of the above system. This can be checked by means of solving a linear programming problem, as the set Pⱼ is given by linear constraints. If such an element exists, it is added to \tilde{P}ⱼ and the above system is re-optimized. This process is repeated until no improving element exists for all windows wⱼ. If the resulting total penalty then equals zero, a solution of equation (3) exists, otherwise no feasible solution exists.

Now, given a relative ordering of starting times and ending times of tasks, together with a resource assignment, it is possible to determine by means of the technique described above whether absolute starting times, ending times and task processing speeds exist, which satisfy or at least minimize any violation of the constraints. It is possible to modify the relative ordering or resource assignment as obtained from the ordering module 202, by determining at least one of a new relative starting time for a task, a new relative ending time for a task, and a new assignment of a resource to a task, and then to check if the minimal constraint violations can be reduced, or whether it is possible to increase the set of scheduled activations. These changes are small, thus the resulting changes in the sub-problem are also small, allowing an incremental computation of absolute times and task processing speeds.

The scheduling module 204 determines the schedule 205, based on the output of the timing module 203. Said schedule 205 comprises for each task a the determined starting time τₛₜ(a) and the absolute ending time τ_{cp}(a), a collection of times and associated task processing speeds (τ₀,π₁,τ₁,π₂, . . . , πₘ,τₘ) and an assignment of resources ρⱼ(a) for each group j.

The schedule 205 can then be presented to a human supervisor, or be automatically used in the system of FIG. 1 to execute the tasks on the resources according to the schedule.

1. A method of determining a schedule (205) for executing a plurality of tasks (301-308) requiring a plurality of resources (101-103, 109-113), comprising the steps of
(a) constructing a set of constraints from given requirements of each task (301-308)and from given limitations on each resource (101-103, 109-113);
(b) determining for each task (301-308) a relative starting time, a relative ending time and an assignment of resources (101-103, 109-113), based on the constraints from said set;
(c) determining for each task (301-308)an absolute starting time, an absolute ending time and a collection of times and associated task processing speeds, based on the determined relative starting time, relative ending time and assignment of resources (101-103, 109-113) for said task, minimizing any violation of the constraints from said set; and
(d) determining the schedule (205), comprising for each task (301-308) the determined absolute starting time, absolute ending time, collection of times and associated task processing speeds and assignment of resources (101-103, 109-113) to said task.

2. A method as claimed in claim 1, where step (c) comprises
defining a sequence of windows (w₀ , . . . , w₁₅), a starting time of a window (w₀ , . . . , w₁₅) from said sequence corresponding to one of the relative starting time and the relative ending time of a task (301-308), and an ending time of said window (w₀ , . . . , w₁₃) corresponding to a starting time of a next window (w₀ , . . . , W₁₅) in said sequence;
determining an absolute length of the windows (w₀ , . . . , w₁₃) from said sequence, minimizing any violation of the constraints from said set;
determining for each window (w₀ , . . . , w₁₅) a processing speed for each task (301-308) and creating for each task (301-308) a collection of times and associated task processing speeds based thereupon, minimizing any violation of the constraints from said set; and
determining for each task (301-308) the absolute starting time and the absolute ending time from the absolute length of the windows (w₀ , . . . , w₁₅).

3. A method as claimed in claim 1 or 2, further comprising the step of
determining whether any violation of the constraints has occurred, and if so,
determining at least one of a new relative starting time for a task (301-308), a new relative ending time for a task (301-308), and a new assignment of a resource (101-103,109-113) to a task (301-308); and
executing step (c).

4. A method as claimed in claim 2, where the step of determining the absolute length of the windows (w₀ , . . . , w₁₅) from said sequence comprises solving a linear programming problem.

5. A method as claimed in claim 2 or 4, where the step of determining for each window (w₀ , . . . , w₁₅) a task processing speed for each task (301-308) comprises solving a linear programming problem.

6. A scheduler (100) for determining a schedule for executing a plurality of tasks (301-308) requiring a plurality of resources (101-103, 109-113), comprising
constructing means (201) for constructing a set of constraints from given requirements of each task (301-308) and from given limitations on each resource (101-103, 109-113);
ordering means (202) for determining for each task (301-308) a relative starting time, a relative ending time and an assignment of resources (101-103, 109-113), based on the constraints from said set;
timing means (203) for determining for each task (301-308) an absolute starting time, an absolute ending time and a collection of times and associated task processing speeds, based on the determined relative starting time, relative ending time and assignment of resources (101-103, 109-113) for said task (301-308), minimizing any violation of the constraints from said set; and
scheduling means (204) for determining the schedule, comprising for each task (301-308) the determined absolute starting time, absolute ending time, collection of times and associated task processing speeds and assignment of resources (101-103, 109-113) to said task (301-308).

7. A scheduler (100) as claimed in claim 6, where the timing means (203) are arranged to
define a sequence of windows (w₀ , . . . , w₁₅), a starting time of a window (w₀ , . . . , w₁₅) from said sequence corresponding to one of the relative starting time and the relative ending time of a task (301-308), and an ending time of said window (w₀ , . . . , w₁₃) corresponding to a starting time of a next window (w₀ , . . . , w₁₅) in said sequence;
determine an absolute length of the windows (w₀ , . . . , w₁₅) from said sequence, minimizing any violation of the constraints from said set;
determine for each window (w₀ , . . . , w₁₅) a task processing speed for each task (301-308) and create for each task (301-308) a collection of times and associated task processing speeds based thereupon, minimizing any violation of the constraints from said set; and
determine for each task (301-308) the absolute starting time and the absolute ending time from the absolute length of the windows (w₀ , . . . , W₁₅).

8. A scheduler (100) as claimed in claim 6 or 7, being arranged to
determine whether any violation of the constraints has occurred, and if so, to
determine at least one of a new relative starting time for a task (301-308), a new relative ending time & for a task (301-308), and a new assignment of a resource (101-103, 109-113) to a task (301-308); and
activate the timing means (203).

9. A scheduler (100) as claimed in claim 7, further comprising linear programming means (206) for solving a linear programming problem.

10. A system having a scheduler (100) as claimed in claim 6, 7, 8 or 9, and a plurality of resources (101-103, 109-113), the system being arranged to execute the tasks (301-308) on said plurality of resources (101-103, 109-113) according to the schedule (205) obtained from the scheduler (100).
